(19) United States
(12) Patent Application Publication
(10) Pub. No.: US 2010/0037524 A1
(43) Pub. Date: Feb. 18, 2010

(54) Latch for tiltable sash windows

(76) Inventors: Luke Liang, South Plainfield, NJ (US); Tong Liang, Guangzhou (CN); David Chen, Guangzhou (CN)

Correspondence Address: Thomas A. O'Rourke;Bodner & O'Rourke, LLP, Suite 108, 425 Broadhollow Road, Melville, NY, 11747, US

(21) Appl. No.: 12/228,887

(22) Filed: Aug. 15, 2008

(51) Int. Cl. E05C 1/08; E05D 15/22; E06B 3/00

(52) U.S. Cl. 49/176; 292/163; 49/506

(57) ABSTRACT

A latch is provided for use principally on a pivotal sash window of a double-hung sash window assembly. The latch comprises a latch-bolt slidably mounted within and biased relative to a housing, where the housing is mounted to the top rail of the sash window. The latch bolt is connected to a button for manual actuation of the latch bolt. The latch bolt, while maintaining the convenience and utility of a standard short throw latch, is contoured and designed to maintain engagement with the jam after the window has been deformed under high sustained wind loading typically experienced during extreme weather phenomena such as hurricanes and tornados. The engagement is assured in spite of twisting of the latch bolt within the corresponding opening in the jam.

### FIELD OF THE INVENTION

This invention relates to a tilt latch mechanism for use in a pivotable sash window, and more particularly to a latch bolt designed to efficiently withstand high wind loading while simplifying installation into a window.

### BACKGROUND OF THE INVENTION

One of the most valuable and cherished possessions, for many people, is unquestionably his or her own home, which is reflected by the fact that home improvement beyond the traditional contractor renovation has become a major industry. These home improvements include upgrades in older homes in the form of upgraded electrical service, copper plumbing, and particularly replacement windows. A longstanding reason for window replacement, in addition to improved curb appeal, had been the dramatic improvements in thermal efficiency of the double-paned window arrangement, which had already been incorporated into most new construction.

However, windows to be utilized for either new construction or as replacements have seen further improvement as a result of advances in building technology. Improvements to fenestration products have in part been driven by the need to meet more demanding national standards, and in some locations, local building codes which are even more stringent.

A major factor in devising such strict requirements is the ability of the windows to resist damage caused by storms, where storm damage to homes is typically attributable to the storm surge, flood damage, and wind damage. Damage attributed to hurricane Katrina striking the New Orleans area is estimated to be $81.2 billion dollars, and although much of that amount had been due to the flooding which resulted from the levee breaks, shattered windows from hurricane force winds is a significant contributor. Katrina had reached category five in intensity on the Saffir-Simpson Hurricane Scale, but then dropped to category three intensity once it made landfall, and maintained sustained winds between 110-130 mph. Hurricane Andrew, which in 1992 actually struck the Miami-Dade part of Florida at category five, had been the most costly natural disaster in American history, at roughly $26 billion. Victims of hurricane Andrew reported trying to ride out the storm while listening to the category five winds in excess of 156 mph shatter windows, with the glass being dispersed everywhere.

There were similar reports when hurricane Hugo struck South Carolina in 1989, devastating parts of historic Charleston. While the problem may be more often faced by residents of the southern and gulf states, it is not limited to those geographic areas. The “Great September Gale of 1815” was a category three hurricane that struck Long Island, New York, and broke through the barrier beach to create the inlet that still isolates Long Beach. Also, the New York Hurricane of 1893 directly struck New York City, and the Great New England Hurricane in 1938 killed over 682 people and cause over $4.7 billion in damage (2005 U.S. dollars). On average, a hurricane will make landfall in New England every 10-20 years, with last such case being Hurricane Bob in 1991, which killed ten people and caused 2.8 billion dollars in damage (2005 U.S. dollars). Window damage caused by weather phenomena, although very costly and common because of coastal hurricanes, is also problematic for many parts of the country that experience similar risk of damage during tornado season.

However, many if not most coastal areas now mandate that the windows installed be constructed to be both impact resistant and to satisfy other standards. One such standard includes a requirement that the window be able to withstand, for a set period of time, a certain design pressure (DP). A window with a DP30 rating, which would permit the window to maintain its integrity throughout the sustained winds of a category three hurricane, is rated to a pressure level equivalent to 110 mph wind speed, but is tested structurally at a pressure equivalent to 164 mph. Similarly, a window with a DP40 rating is rated to a pressure level equivalent to a 127 mph wind speed, but is tested at a pressure equivalent to a wind speed of 190 mph, and a DP50 rating requires satisfaction of even higher load requirements. Under high wind loading, it is not uncommon to see a window convex a couple of inches, but when properly designed, the window will regain its original form within the window frame. But this deformation under high wind loads creates another design consideration relating to the hardware.

A typical latch for a slidable sash window is shown by U.S. Pat. No. 4,901,475 to Simpson. A latch bolt is spring-loaded relative to its housing, and capable of movement between a retracted or unlatched position, and an extended or latched position. Only a relatively short throw is needed to retract the latch bolt and permit movement of the sash window.

Similarly, another latch for a tilt window is shown by U.S. Pat. No. 7,171,784 to Eenigenberg. The Eenigenberg latch has the same characteristic short throw to retract the latch bolt within the housing, but additionally offers structure permitting its use as a right-hand or a left-hand latch bolt.

Although the short throw characteristic of these tilt-window latches is very desirable, in terms of convenience to the user, and is satisfactory as far as the utility required for personal security, it is deficient maintaining latch integrity during severe weather conditions. Under the high wind loads experienced during a hurricane, the associated deformation to the window may cause the latch bolt to twist and thus the flat face of the bolt will not remain fully engaged with the jam. Also, the deformation, due to the convexing of the window from the winds, may reduce the amount by which any portion of the latch bolt remains engaged with the jam.

A simple solution to the problem would of course be to use a longer latch bolt, and to design the arrangement to have a longer throw, or travel distance, between the engaged and disengaged positions. However, that approach dilutes the advantageous nature of a quick release latch, where any user is able to easily open the window or rotate the window for cleaning, which generally occurs with far greater frequency than that for which such improved hurricane resistance characteristics are normally needed. This invention discloses a tilt latch capable of maintaining its integrity during high wind loading, while maintaining the convenience and overall utility of a short-throw latch bolt.

### SUMMARY OF THE INVENTION

The latch of this invention is designed to be able to resist the “twist-out” effect that occurs when a window undergoes substantial deformation, which may occur as a result of the high sustained winds found in a hurricane, as well as the winds that may be found around the periphery of a tornado. The latch features disclosed herein may be utilized on any number of different latch types, but they are particularly useful for the sash window of a tiltable double hung window assembly.

The latch of this invention features a latch bolt, which is biased relative to the sash window, and is capable of resisting twist out effect without requiring large-scale changes to the latch bolt, which would affect its size and ease of use, particularly with regard to the throw of the latch. The throw of the latch bolt is unaffected by incorporation of the features of this invention.

The latch of this invention comprises a couple of different features. In order to successfully counter twist-out effect without modifying the size of the latch bolt and its throw, the nature of engagement of the face of the latch bolt tongue with the window jam becomes critical. Improvements to that engagement may be accomplished herein through a number of different embodiments. In one embodiment, an angled groove passes across the face of the latch bolt tongue in a direction roughly in line with the direction of the jam. The groove may begin at either the upper or the lower edge of the tongue, or may also alternatively begin at some position in between the upper and lower edges of the tongue. The angled groove feature has a combined effect, the first of which involves the creating an angled face on the tongue face, where the angle of the face may be designed for a particular size window so as to become flush with the jam, when the window and latch are experiencing high wind loads and deformation leading to twisting of the latch. In addition, the angled groove also creates lateral faces which may catch upon the window jam flange to aid the latch in resisting disengagement from the jam.

This angled groove may also, in another embodiment, be utilized in two places on the latch tongue. The tongue may have one angled groove beginning at some mid-point on the latch tongue front face and running towards the upper edge with progressively increasing depth, while another angled groove begins just below the first angled groove and runs down towards the lower tongue edge with progressively increasing depth. This tongue configuration would permit the latch bolt to be utilized in either a left-hand or a right-hand installation.

Another possible embodiment would have a groove which is not angled but rather parallels the front face of the latch bolt tongue. This parallel groove, similar to the angled groove, could run from top to bottom, bottom to top, or may alternatively run in either direction while beginning at some intermediate point between the upper and lower edge of the tongue. Additionally, the tongue of the latch bolt could have two such parallel grooves where one runs towards the top edge of the tongue, and the other runs down to the bottom edge of the tongue, with both grooves beginning at some intermediate point between the upper and lower edge of the tongue.

It should be apparent to one skilled in the art that although such a latch may typically be used for a tiltable sash window which rotates downward and inward (see FIG. 1), it could also be used be used for a window that rotates clockwise and inwards or counterclockwise and inwards, in which case use of the terms up or down in describing the direction the groove runs on the tongue front face may presumably be replaced by left and right. The latch is not limited to a horizontal installation despite the fact that certain terminology herein suggests that such a situation is possible if not likely.

### OBJECTS OF THE INVENTION

It is an object of this invention to provide a latch to be installed on the top rail of a sash window of a tiltable double hung window assembly.

It is a further object of this invention to provide a latch in which the latch bolt may be toggled from the latched to the unlatched position with a short throw.

It is another object of this invention to provide a latch that can maintain positive contact with a window jam during sustained winds of a hurricane.

It is another object of this invention to provide a latch that can maintain positive contact with a window jam during sustained winds associated with the periphery of a tornado.

It is another object of this invention to provide a latch that can maintain positive contact with a window jam during load conditions imposed by pressure testing to simulate hurricane force winds.

It is another object of this invention to provide a latch that can maintain positive contact with a window jam under conditions in which the window experiences severe deformation.

It is another object of this invention to provide a window latch that can resist latch “twist-out” effect during high wind loading.

### BRIEF DESCRIPTION OF THE DRAWINGS

FIG. 1 is a perspective view of a tiltable sash window utilizing the latch of this invention, with part of the master window frame removed to reveal latch details.

FIG. 2 is an enlarged perspective view of the latch details of FIG. 1.

FIG. 3 is a perspective view of a 1^{st} embodiment of the latch of the current invention.

FIG. 4 is a perspective view of a 2^{nd} embodiment of the latch of the current invention.

FIG. 5 is a perspective view of a 3^{rd} embodiment of the latch of the current invention.

FIG. 6 is a perspective view of a 4^{th} embodiment of the latch of the current invention.

FIG. 7 is a perspective view of a 5^{th} embodiment of the latch of the current invention.

FIG. 8 is a perspective view of a 6^{th} embodiment of the latch of the current invention.

FIG. 9 is a perspective view of a 7^{th} embodiment of the latch of the current invention.

FIG. 10 is a perspective view of a 8^{th} embodiment of the latch of the current invention.

FIG. 11 is a perspective view of a 9^{th} embodiment of the latch of the current invention.

FIG. 12 is a perspective view of a 10^{th} embodiment of the latch of the current invention.

FIG. 13 is an enlarged perspective view of the 4^{th} embodiment of the latch according to the invention.

FIG. 14 is an enlarged perspective view of an 11^{th} embodiment of the latch according to the invention.

FIG. 15 is a side view of the first side of the 11^{th} embodiment of the latch according to the invention.

FIG. 16 is a bottom view of the 11^{th} embodiment of the latch according to the invention.

FIG. 17 is a side view of the second side of the 11^{th} embodiment of the latch according to the invention.

FIG. 18 is an end view of the 11^{th} embodiment of the latch according to the invention.

FIG. 19 is an exploded view of the parts comprising the 11^{th} embodiment according to the invention.

FIG. 20 is an exploded view of the reverse side of the parts comprising the 11^{th} embodiment according to the invention.

FIG. 21 is a bottom perspective view of the 11^{th} embodiment of the latch according to the invention, before installation.

FIG. 22 is a perspective view of the 11^{th} embodiment of the latch and the sash window frame, before installation of the latch.

FIG. 23 is a section cut through the 11^{th} embodiment of the latch and sash window rail and stile, after installation of the latch.

### DETAILED DESCRIPTION OF THE PREFERRED EMBODIMENT

The latch design features of the present invention may be incorporated for use into any one of the various different latch configurations of the prior art, as well as others which may be created. The advantageous nature of these design features, which may be incorporated in whole or in part, are best described in terms of one of the particular latch embodiments, which may be utilized in many different applications, but are particularly useful for a tiltable sash window of a double-hung sash window assembly.

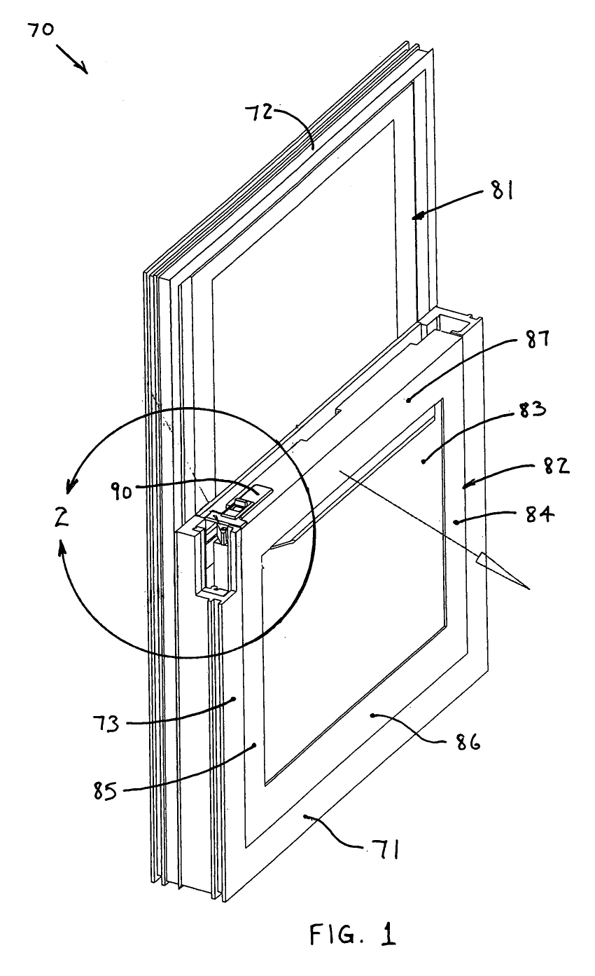

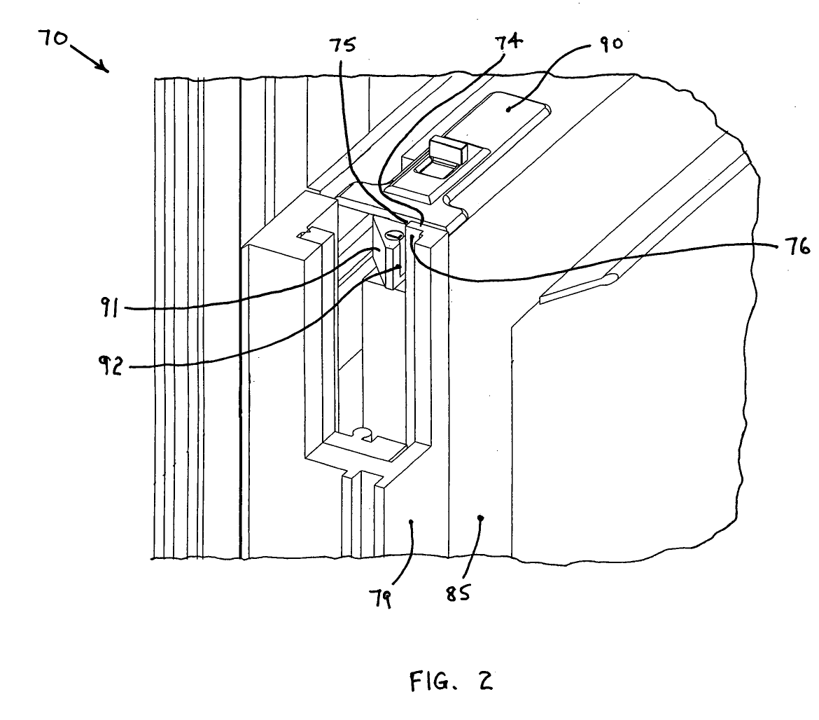

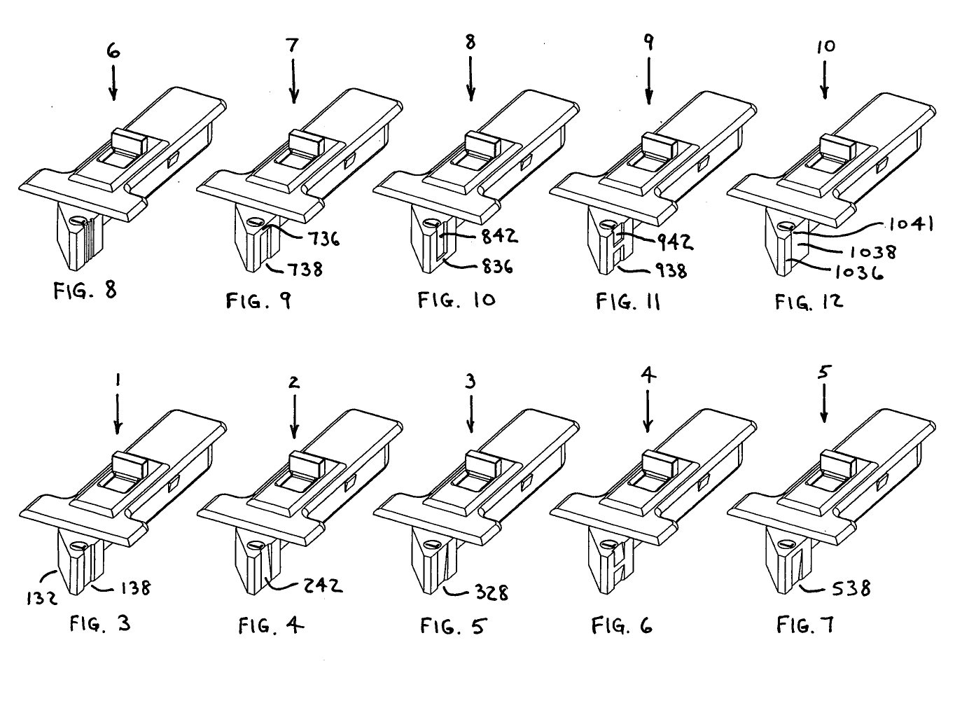

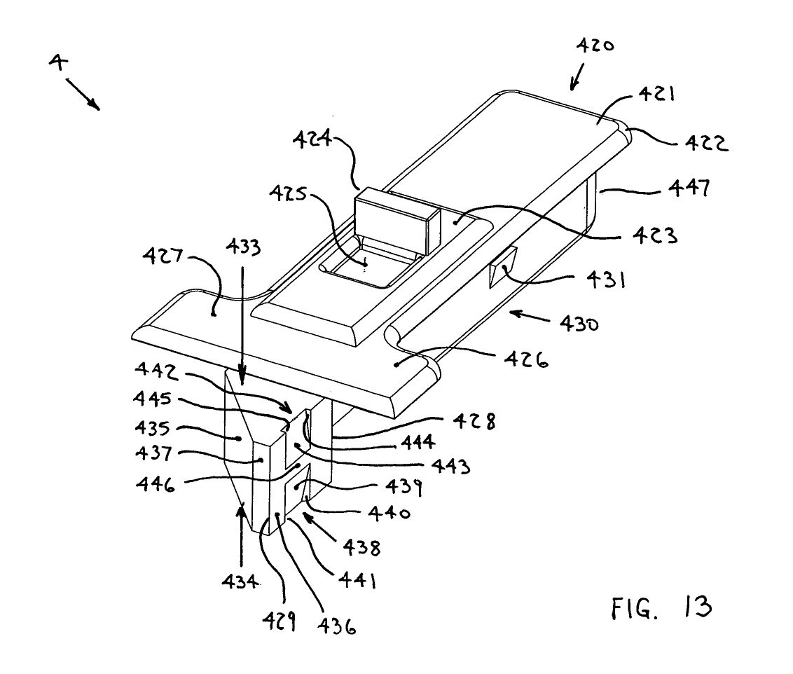

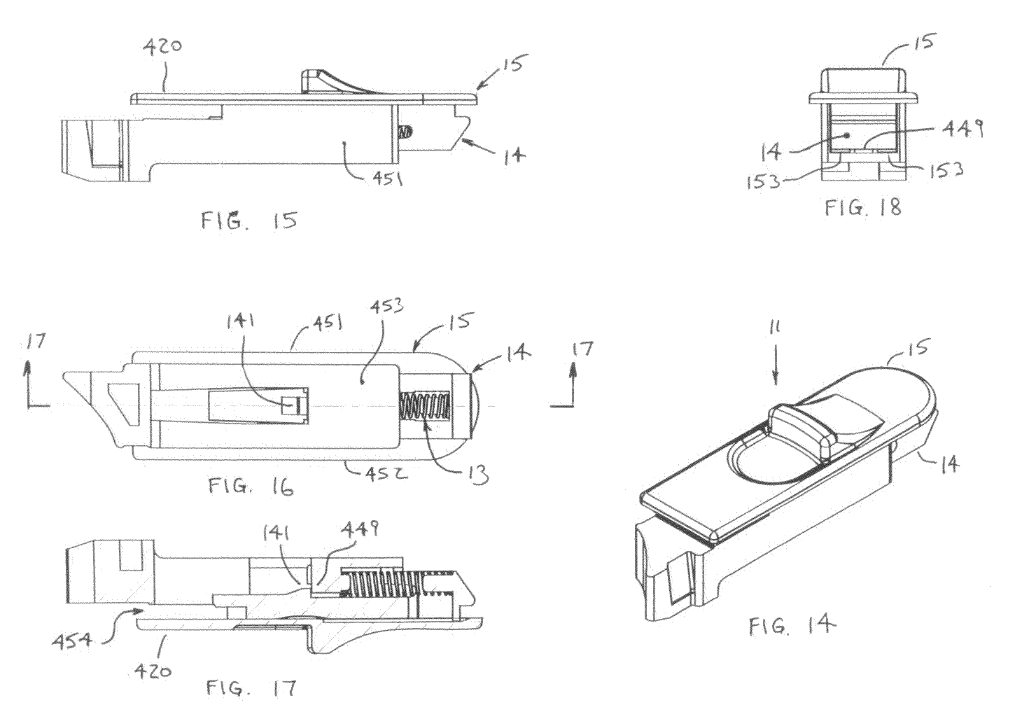

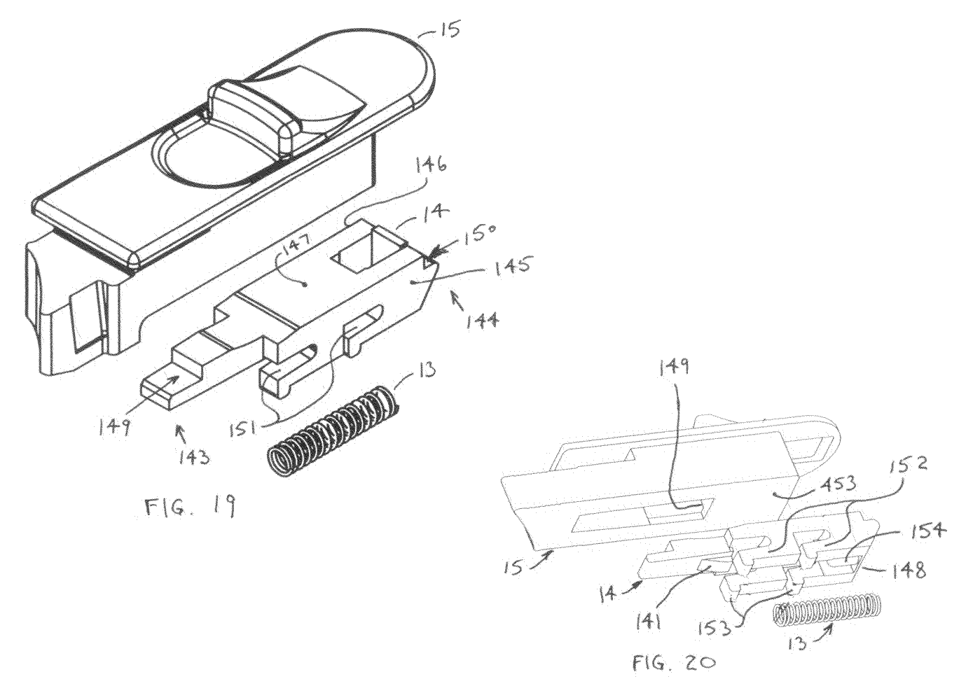

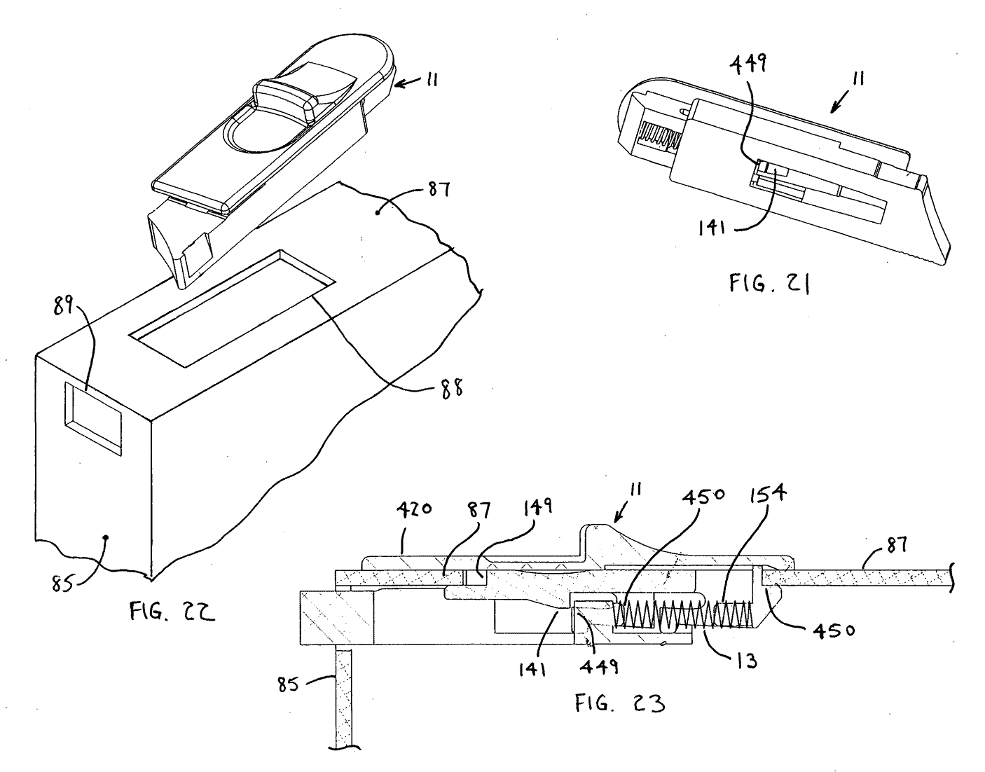

FIG. 1 depicts a tiltable single-hung or double hung window assembly 70 with an upper sash window 81, lower sash window 82, and a master frame consisting of a sill portion 71, a head jam 72, and side jams 73. Portions of the head jam 72, and the side jams 78 have been cut away in the figure in order to illustrate the features of the jam with which the latch interacts. The lower sash window 82 is comprised of bottom rail 86, top rail 87, and stiles 84 and 85, which support the edge of the glazing, or glass pane 83. As is common for a tiltable double-hung sash window, the lower portion of the window has a connection to the frame (not shown) which is both pivotable and slidable with respect to the frame, and the upper portion of the window has a latch 90 with a tongue 91 which is also slidable with respect to the jam, but may also be retracted to permit the lower sash window 82 to rotate inward (see FIG. 2).

The tongue 91 of the latch 90 normally prevents the window from rotating inward, because, until the latch bolt is toggled, the front face 92 of the tongue 91 bears up against the bearing surface 75 of the side jam flange 74. It is this connection, as previously discussed, which is critical to withstand the high wind loads. When substantial deformation to the window occurs as a result of high wind loading, causing the latch bolt to twist, the flat front face 92 of the tongue 91 will not remain fully engaged with the jam. The twisting will tend to result in only one edge of the front face 92 making contact with the bearing surface 75 of jam flange 74, and additionally, the deformation due to the convexing of the window may further cause the tongue to be angled with respect to a vertical axis, such that only a portion of the bottom edge of the tongue maintains contact with the jam flange at the inner edge of the jam flange. These deformations make the latch subject to “twist-out” effect whereby the jam does not positively restrain the latch tongue, and the window may rotate under such loading.

A series of design modifications to the latch tongue found in this invention negate this effect, and are shown by the various exemplary embodiments of FIGS. 3-12. The advantageous nature of the design is illustrated by the latch embodiment 4 shown in FIG. 6, and also in FIG. 13 but at a larger scale. However, each of the latch embodiments shown in FIGS. 3-12 represent substantial improvements over a conventional latch in order to provide it with improved characteristics necessary to resist twist-out effect.

The latch 4 embodiment (FIG. 13) comprises the latch body 420 which is a combination latch bolt and trigger, a spring 13 (FIG. 19) and fixed member 14. The fixed member 14 is set against the top rail 87 of the lower sash window 82, and in conjunction with spring 13, biases the latch body relative to the top rail 87 (FIG. 23). The combination of latch body 420, spring 13, and fixed member 14 may be installed through a pair of openings 88 and 89 (FIG. 22), which may be punched in the top rail and stile respectively. The size and position of the openings 88 and 89 may be coordinated to match the size of and spatial relationship between the tongue and latch bolt body.

The latch body 420 (FIG. 13) may comprise a top plate 421 which may sit flush atop the top rail 87. The top plate 421 may have rounded comers 422 for aesthetic appeal as well as for providing a safer end of the part as opposed to having a sharp edge. Protruding upward from the top plate is toggle button 424. Immediately adjacent to toggle button 424 is a recess 425 which permits the button to have a larger surface area that may be contacted by the thumb or fingers of the user seeking to pivot the window, while permitting a reduced height toggle button that protrudes at an unobtrusive height above the top rail 87. The top plate 421 may additionally have a raised area 423 if desired, as well as lateral extensions 426 and 427.

The latch body 420 may further comprise a latch bolt housing 430 that may be either attached to or integral to the top plate 421. The housing 430 may have a first side wall 451, a second side wall 452, and a bottom wall 453, and the housing 430 has a first end 447 that may facilitate biasing of the latch bolt body relative to the window top rail 87, as will be seen later, and a second end 448 which terminates in latch bolt tongue 432. The housing 430 may also have a plurality of protrusions 431 which may assist in retaining the latch bolt body within the top rail 87. Latch bolt tongue 432 may be attached to or integral to the housing 430 and top plate 420.

Latch bolt tongue 432 may have a top surface 433 and bottom surface 434, which need not be, but is however shown as being generally parallel in the latch 4 embodiment, and the other embodiments. Furthermore, top surface 432 and bottom surface 433 need not be flat, and may conversely be curved in one or more directions. The latch bolt tongue 432 may also have a back face 435 that is slanted with respect to front bearing face 436, which extends between top surface 432 and bottom surface 433. The slanted face 435 and front bearing face 436 may form a sharp edge or may alternatively be formed so as to have a chamfered tip 37, or even a rounded tip. One end of the front face 436, as it meets the tip—either chamfered, rounded or a sharp edge—is its outer end 429, and is opposite the inner end 428. Outer end 429 and inner end 428 need not be parallel, and they need not form a linear edge.

Front bearing face 436, which will normally be flush against the bearing surface 75 of side jam flange 74, may be interrupted by a step feature, which, for embodiment 4 may comprise lower angled groove 438. Lower angled groove 438 may be created by the lower groove face 439 which is angled with respect to front bearing face 436 and thus would also form a first lateral face 440 and second lateral face 441. The groove face in this embodiment is flat, however, it could also be curved in this and any other embodiment. These lateral faces may similarly be flat, or they may be curved, or they may initially be flat and thereafter transition into a curved portion, essentially forming a fillet radius between a flat portion of the lateral face and the groove face. Also, these lateral faces 440 and 441 may be perpendicular to front bearing surface 436, or they may be angled with respect to front bearing surface 436 and may thus be so designed to catch a lip or recess formed at the junction of bearing surface 75 and side bearing surface 76 of side jam flange 74. The lateral faces may also be generally triangular in shape. In other embodiments described in subsequent paragraphs, when the groove face may have a different orientation with respect to the tongue front bearing face, these lateral faces may then be generally rectangular in shape, trapezoidal in shape, or possibly an irregular shape.

The step feature of the latch 4 embodiment may also comprise the front bearing face 436 being interrupted by an upper angled groove 442, which is similarly created by upper groove face 443, and first and second lateral groove faces 445 and 445, respectively. The front bearing face 436 being interrupted by lower angled groove 438 and upper angled groove 442 results in the front bearing surface 436 resembling an “H” shape, where the connecting portion or surface 446 would normally be in contact with the bearing surface 75 of side jam flange 74.

When the window 70, and consequently the latch 4, is subjected to the high wind load conditions, the design of the latch bolt tongue 432 enables the latch to resist the “twist-out” effect and remain positively engaged with the side jam flange 74 for a combination of reasons.

First, as the latch experiences twisting due to the wind loading, the connecting surface 446 that had been bearing upon bearing surface 75 of window 70, is now angled away from the bearing surface 75, but the angled groove face of the tongue 432 may now be flush to bearing surface 75. It can be appreciated by one skilled in the art, that the size and shape of a particular window will affect the magnitude of loading and twisting to the latch 4 installed in such a window, because the increased surface area of a larger window will produce higher loads under a 30, 40, or a 50 pound per square foot wind load condition, than a smaller window, and this load must be reacted by the latch 4. Therefore, the relative angle between the groove face 439 or 443, and the front bearing face of the tongue 436 (and more particularly connecting surface 446) may be increased or decreased for a particular window latch to accommodate such loading and twisting for a particular window design. In fact, that relative angle should necessarily be different and be custom designed for each particular window configuration.

Secondly, and perhaps more significant for the latch 4 to resist the high wind-loading, is the fact that lower angled groove 438 creates the lateral groove face 441, and similarly the upper angled groove 442 creates lateral groove face 445. When high sustained winds would create deformation that would tend to pull the tongue from the opening in the jam and permit the window to unexpectedly rotate, these lateral faces 441 and 445 may engage the side bearing surface 76 (see FIG. 2) of side jam flange 74 of window 70 to resist such loading.

While it would be apparent to one skilled in the art that loading of the window 70 will only produce twisting in one particular direction, so that having both the lower and upper angled grooves 438 and 443 on the latch 4 as installed in FIG. 2, would not be necessary, it is nonetheless beneficial. Having the tongue designed and manufactured as shown with both lower groove 438 and upper groove 443 allows the latch bolt to be utilized in either of the left-hand or the right-hand latch positions of the window 70.

The advantageous nature of constructing the tongue 432 of a window latch 4 as shown in FIGS. 6 and 13, may also be recognized in the other possible embodiment as shown in FIGS. 3-5 and FIGS. 7-12. In the latch embodiment 1 of FIG. 3, the tongue 132 has a step feature in the form of a single groove 138, and unlike embodiment 4, the groove 138 is not angled with respect to the front bearing face of the tongue and actually parallels the front bearing face. Although this embodiment would not have an angled bearing surface to be flush with bearing surface 75 (see FIG. 2) of side jam flange 74 of window 70 as with embodiment 4, it would still be capable of meshing with the side bearing surface 76 to resist the tendency of the wind loading to pull the tongue from the opening.

The embodiments 7 and 8, shown in FIGS. 9 and 10, may each have a parallel groove, 738 and 842 respectively, as with embodiment 1, but for embodiments 7 and 8 the parallel grooves 738 and 842 do not run vertically across the entire front bearing face, as there are connecting surfaces 736 and 836 respectively, which are comparable to connecting surface 436 of embodiment 4. Embodiment 9 incorporates a combination of both an upper and a lower groove, such that it may, like embodiment 4, be utilized in either of the left-hand or the right-hand latch positions of the window 70.

Embodiments 2 and 3 each have a single angled groove 242 and 328 respectively, and permit a similar response by the latch tongue to wind loading as with embodiment 4. However, embodiments 2 and 3 do not have a bearing surface, comparable to surface 446 of embodiment 4, which normally is flush to the bearing surface 75 of side jam flange 74 of window 70. The angled groove 242 of embodiment 2 begins at the tongue bottom surface, and can have some initial depth or may essentially have no depth or a zero depth where the groove begins at the bottom surface, but in either case the groove will have increasing depth with increasing distance from the bottom surface. Angled groove 328 may be similarly formed, but would actually begin at the tongue top surface and have increasing depth with increasing distance from the top surface.

Embodiment 5, shown in FIG. 7, is essentially configured like embodiment 4, except that it has only one angled groove 538, and thus would not be capable of installation in either the left-hand or right-hand latch positions as would be embodiment 4, nor would embodiments 2 and 3 have that left-hand right-hand installation advantage. However, utilizing only the single angled groove of embodiment 5 permits the groove to run across a greater vertical distance on the tongue for a given angle, which results in an increase in the depth of the lateral face which may engage the side bearing surface 76.

One additional embodiment that would be advantageous in resisting high sustained wind loading, is shown by embodiment 10 in FIG. 12. Embodiment 10 has a surface 1038 that is offset from and parallel to face 1036. Surface 1038 begins at the inner end of face 1036 so as to create a lateral face 1041, which may engage the side bearing surface 76 of side jam flange 74 of window 70, as already discussed.

Other modifications, substitutions, omissions and changes may be made in the design, size, materials used or proportions, operating conditions, assembly sequence, or arrangement or positioning of elements and members of the preferred embodiment without departing from the spirit of this invention as described in the following claims.

We claim:

1. A latch, for use in fenestration products, said latch comprising:
(a) a latch bolt; said latch bolt comprising a latch bolt tongue, said latch bolt tongue having a front face, said front face extending between a top surface and a bottom surface and between an outer end and an inner end, said front face having a step feature; said latch bolt further comprising a housing, said housing comprising a top plate, a bottom wall, and first and second side walls, said first and second sidewall extending from at least a portion of said top plate, said bottom wall connecting to at least a portion of said first and second side walls, said top plate, bottom wall and first and second side walls therein forming a cavity, said cavity having at least a first opening;
(b) a fixed member, said fixed member disposed in said cavity of said latch bolt housing, wherein at least a portion of said fixed member protrudes from said first opening in said latch bolt housing; and
(c) a spring means, wherein said spring means biases said latch bolt relative to said fixed member.

2. The latch according to claim 1 wherein said fenestration product is a tiltable sash window of a double-hung window assembly.

3. The latch according to claim 1 wherein said step feature comprises a recess.

4. The latch according to claim 1 wherein said step feature comprises a recess having a wall, and first and second lateral faces.

5. The latch according to claim 1 wherein said step feature of said front face comprises one or more grooves.

6. The latch according to claim 5 wherein a groove of said one or more grooves comprises a groove face and first and second lateral faces.

7. The latch according to claim 6 wherein said lateral faces are flat.

8. The latch according to claim 7 wherein said first and second lateral faces are perpendicular to said tongue front face.

9. The latch according to claim 7 wherein said first and second lateral faces are at an acute angle relative to said tongue front face.

10. The latch according to claim 7 wherein said first and second lateral faces are at an obtuse angle relative to said tongue front face.

11. The latch according to claim 7 wherein said groove further comprises a first curved surface and a second curved surface, said first curved surface connecting said first lateral face to said groove face, and said second curved surface connecting said second lateral face to said groove face.

12. The latch according to claim 6 wherein said lateral faces are curved.

13. The latch according to claim 6 wherein said groove face is flat.

14. The latch according to claim 6 wherein said groove face is curved.

15. The latch according to claim 6 wherein said groove face is parallel to said front face of said tongue.

16. The latch according to claim 15 wherein said groove begins at said bottom surface of said tongue and runs toward said top surface of said tongue, said groove reaching said top surface.

17. The latch according to claim 15 wherein said groove begins at said bottom surface of said tongue and runs toward said top surface of said tongue, said groove ending before reaching said top surface.

18. The latch according to claim 15 wherein said groove begins at said top surface of said tongue and runs toward said bottom surface, said groove ending before reaching said bottom surface.

19. The latch according to claim 15 wherein said one or more grooves comprises:
(a) a first groove, said first groove beginning at said bottom surface of said tongue and running towards said top surface, said first groove ending before reaching said top surface; and
(b) a second groove, said second groove beginning at said top surface of said tongue and running towards said first groove, said second groove ending before reaching said first groove.

20. The latch according to claim 19 wherein said first groove and said second groove end approximately mid-way between said top surface and said bottom surface of said tongue.

21. The latch according to claim 6 wherein said groove face is angled with respect to said front face of said tongue.

22. The latch according to claim 21 wherein said angled groove begins at said bottom surface of said tongue and runs towards said top surface, said angled groove having zero depth at said bottom surface and having increasing depth with increasing distance from said bottom surface, said angled groove ending at said top surface of said tongue.

23. The latch according to claim 21 wherein said angled groove begins at said bottom surface of said tongue and runs towards said top surface, said angled groove having a depth at said bottom surface and having increasing depth with increasing distance from said bottom surface, said angled groove ending at said top surface of said tongue.

24. The latch according to claim 21 wherein said angled groove beginning at said top surface of said tongue and runs towards said bottom surface, said angled groove having zero depth at said top surface and having increasing depth with increasing distance from said top surface, said angled groove ending at said bottom surface of said tongue.

25. The latch according to claim 21 wherein said angled groove beginning at said top surface of said tongue and runs towards said bottom surface, said angled groove having a depth at said top surface and having increasing depth with increasing distance from said top surface, said angled groove ending at said bottom surface of said tongue.

26. The latch according to claim 21 wherein said angled groove begins at a position in between said bottom surface and said top surface of said tongue and runs toward said top surface, said groove having zero depth at said beginning position and having increasing depth with increasing distance from said beginning position, said groove ending at said top surface of said tongue.

27. The latch according to claim 21 wherein said angled groove begins at a position in between said bottom surface and said top surface of said tongue, and runs toward said bottom surface, said groove having zero depth at said beginning position and having increasing depth with increasing distance from said beginning position, said groove ending at said bottom surface of said tongue.

28. The latch according to claim 21 wherein said one or more angled grooves comprise:
(a) a first angled groove, said first angled groove beginning at a position in between said bottom surface and said top surface of said tongue and running towards said top surface, said first angled groove having zero depth at said beginning position and having increasing depth with increasing distance from said beginning position, said first angled groove ending at said top surface of said tongue; and
(b) a second angled groove, said second angled groove beginning at a position in between said bottom surface of said tongue and said beginning of said first angled groove, said second angled groove running towards said bottom surface, said second angled groove having zero depth at said beginning position and having increasing depth with increasing distance from said beginning position, said second angled groove ending at said bottom surface of said tongue.

29. The latch according to claim 28 wherein said beginning of said first angled groove and said beginning of said second angled groove is approximately mid-way between said top surface and said bottom surface of said tongue

30. The latch according to claim 1 wherein said step feature of said front face comprises a surface, said surface being offset from and parallel to said front face of said tongue, said surface beginning at said inner end of said front face, said surface being connected to said front face by a lateral face.

31. The latch according to claim 30 wherein said lateral face is perpendicular to said front face.

32. The latch according to claim 31 wherein said lateral face is at an angle to said front face.

33. The latch according to claim 1 wherein said housing further comprises a face plate.

34. The latch according to claim 1 wherein said latch further comprises a fixed member, and wherein said spring biases said latch bolt relative to said fixed member.

35. The latch according to claim 1 wherein said latch further comprises a means for retracting said latch bolt.

36. The latch according to claim 35 wherein said means is a button.

37. The latch according to claim 35 wherein said means is a recess in a surface of said latch.

38. The latch according to claim 1 wherein said spring means is a compression spring.

39. The latch according to claim 1 wherein said spring means is a tension spring.

40. A method for securing a tiltable sash window of a double-hung window assembly against high wind loads associated with hurricanes and other extreme weather phenomena, said method comprising the steps of:
(a) providing a latch capable of resisting twist-out effect occurring as a result of convexing and the window deformation of such wind loading, said pair of latches comprising left-hand and right-hand latches to engage respective opposing side jam flanges, where said left-hand and right-hand latches comprise:
(1) a latch bolt; said latch bolt comprising a latch bolt tongue, said latch bolt tongue having a front face, said front face extending between a top surface and a bottom surface and between an outer end and an inner end, said front face having a step feature; said latch bolt further comprising a housing, said housing comprising a top plate, a bottom wall, and first and second side walls, said first and second sidewall extending from at least a portion of said top plate, said bottom wall connecting to at least a portion of said first and second side walls, said top plate, bottom wall and first and second side walls therein forming a cavity, said cavity having at least a first opening;
(2) a fixed member, said fixed member disposed in said cavity of said latch bolt housing, wherein at least a portion of said fixed member protrudes from said first opening in said latch bolt housing; and
(3) a spring means, wherein said spring means biases said latch bolt relative to said fixed member.
(4) a means for retracting said latch bolt, said means comprising a surface which may be contacted by a user to retract said lock bolt;
(b) forming coordinated punched openings in the top rail and the stile on the left-hand side of the window frame;
(c) forming coordinated punched openings in the top rail and the stile on the right-hand side of the window frame;
(d) installing on the left-hand side of the sash window said left-hand twist-out resistant latch such that said groove on said front face of said tongue is in-line with the window jam flange;
(e) installing on the right-hand side of the sash window said right-hand version of said twist-out resistant latch such that said groove on said front face of said tongue is in-line with the window jam flange;

41. A latch for use in locking at least one sash of a sash window, said latch comprising: a latch bolt housing, said latch bolt housing comprising an installation means and a latch bolt tongue, said latch bolt tongue including a surface with an engagement feature.

42. The latch according to claim 41 wherein said engagement feature comprises one or more grooves upon said face of said latch bolt tongue.

43. The latch according to claim 42 wherein said one or more grooves comprises one or more angled grooves, and wherein each of said one or more angled grooves comprises a groove with a depth that varies across said face of said tongue.

44. The latch according to claim 41 wherein said engagement feature comprises a step in said face of said latch bolt tongue.

45. The latch according to claim 43 wherein said installation means comprises said housing comprising at least one housing wall and a top plate, said top plate overhanging beyond said at least one housing wall, said top plate and said at least one housing wall forming a cavity with a first opening; said latch bolt tongue protruding from at least a portion of said at least one housing wall, said tongue protruding beyond said top plate; and a member, said member comprising a top wall, and at least one side wall extending from said top wall, said member having a first end and a second end; said top wall at said first end having a recess; said member having an end wall at said second end that connects said top wall and said at least one side wall; said member being linked with said latch bolt housing, and wherein at least a portion of said second end of said member protrudes from said first opening in said latch bolt housing; said protruding portion of said second end having a recess.

46. The latch according to claim 45 wherein said link between said member and said latch bolt housing comprises a spring means, said spring means biasing said latch bolt housing and tongue into a locked position.

47. The latch according to claim 46 wherein said link between said member and said latch bolt housing further comprises said member being disposed in said cavity in said latch bolt housing, wherein at least a portion of said member protrudes from an opening in said latch bolt housing, said spring means biasing said latch bolt relative to said member.

48. The latch according to claim 47 wherein said installation means further comprises receiving a portion of a window top rail, said portion of said top rail being positioned between said top plate of said housing and said recess in said top wall of said member; and receiving a second portion of said window top rail, said second portion of said top rail being positioned between said top plate of said housing and said recess in said protruding portion of said second end of said member.

49. A latch for use in locking at least one sash of a sash window, said latch comprising: a latch bolt housing, said latch bolt housing comprising a top plate, a toggle button extending from said top plate, and a latch bolt tongue; said latch further comprising a member that is slidably disposed in a cavity in said housing; and a spring means, said spring means biasing said latch bolt housing relative to said member; said member having a top wall, a first sidewall, a second sidewall, and a rear wall, said rear wall having a recessed area for receiving a portion of a window top rail, said portion of said top rail being positioned between said top plate of said housing and said recess in said rear wall of said member; said top wall of said member further comprising a recess for receiving a second portion of the window top rail, said second portion of said top rail being positioned between said top plate of said housing and said recess in said top wall of said member.

50. A latch for use in locking at least one sash of a sash window, said latch comprising: a latch bolt housing, said latch bolt housing comprising a top plate with a recess, and a latch bolt tongue; said latch further comprising a member that is slidably disposed in a cavity in said housing; and a spring means, said spring means biasing said latch bolt housing relative to said member, said sash of said window having a stile and a top rail, said stile having a first orifice for said latch bolt tongue to extend therefrom, and said top rail having a second orifice for receiving said housing, said first and second orifices being separated by a portion of an outer surface of said stile and a portion of an outer surface of said top rail.

51. A latch, for use in locking at least one sash of a sash window, said latch comprising:
(a) a latch bolt; said latch bolt comprising a housing, said housing comprising at least one housing wall and a top plate, said top plate overhanging beyond said at least one housing wall, said top plate and said at least one housing wall forming a cavity with a first opening; said top plate comprising a means of actuating said latch; said housing further comprising a latch bolt tongue protruding from at least a portion of said at least one housing wall, said tongue protruding beyond said top plate, and said tongue comprising at least a generally flat bearing surface;
(b) a member, said member comprising a top wall, and at least one side wall extending from said top wall, said member having a first end and a second end; said top wall at said first end having a recess; said member having an end wall at said second end that connects said top wall and said at least one side wall; said member being slidably disposed in said cavity of said latch bolt housing, and wherein at least a portion of said second end of said member protrudes from said first opening in said latch bolt housing; said protruding portion of said second end having a recess; and
(c) a spring means, wherein said spring means biases said latch bolt relative to said member.

52. The latch according to claim 51 wherein said at least one housing wall of said latch bolt comprises a first side wall, a second side wall, and a bottom wall, said bottom wall connecting to at least a portion of said first side wall, and said bottom wall connecting to at least a portion of said second side wall.

53. The latch according to claim 52 wherein said latch bolt tongue protrudes from at least a portion of said first side wall, said second side wall, and said bottom wall.

54. The latch according to claim 53 wherein said at least one side wall of said member comprises a first side wall and a second side wall.

55. The latch according to claim 54 wherein said first and second sidewalls of said member extend from at least a portion of said top wall.

56. The latch according to claim 55 wherein said top wall of said member slidably contacts a bottom side of said top plate of said latch bolt housing.

57. The latch according to claim 56 wherein there is a gap between said top plate of said housing and said tongue.

58. The latch according to claim 57 wherein said gap between said top plate of said housing and said tongue is greater than said recess in said top wall at said first end of said member.

59. The latch according to claim 58 wherein said actuation means is a toggle button, and wherein said toggle button protrudes up from said top plate.

60. The latch according to claim 59 wherein said actuation means is a recess on said top plate.

61. The latch according to claim 60 wherein said spring means is a coil spring, and wherein said member further comprises a post, said post being capable of retaining an end of said coil spring.

62. The latch according to claim 61 wherein said first and second sidewall of said member further comprises a plurality of openings to subdivide said first and second sidewalls each into one or more narrow cantilevered members.

63. The latch according to claim 62 wherein each of said one or more cantilevered members have a downward protrusion, said one or more cantilevered members and said protrusions biasing said member so as to be provide said slidably contact between said top wall of said member and said bottom side of said top plate of said latch bolt housing

64. The latch according to claim 63 wherein said latch is installed by inserting said tongue of said housing into an opening in a rail of a window, and said latch thereafter being positioned so that said tongue protrudes out an opening in a stile.

65. The latch according to claim 64 wherein said positioning of said latch occurs by nesting said latch in said rail opening, one end of said opening in said rail being retained between said top plate of said housing and said recess of said top wall at said first end of said member; a second end of said opening in said rail being retained between said top plate of said housing and said recess in said protruding portion of said second end of said member.

66. The latch according to claim 65 wherein said generally flat bearing surface of said tongue further comprises at least one angled groove, and wherein said at least one angled groove comprises a groove with a depth that varies across said surface of said tongue.

67. A latch for use in locking at least one sash of a sash window, said latch comprising: a latch bolt housing, said latch bolt housing comprising a top plate with an upper and a lower surface; a first and a second side wall extending from said lower surface of said top plate and being connected by a bottom wall; a toggle button extending from said upper surface of said top plate; and a latch bolt tongue, said latch bolt tongue extending from at least a portion of said first side wall and said second sidewall; said latch further comprising a member that is slidably disposed in a cavity in said housing, said member having a top wall, a first sidewall, a second sidewall, and a rear wall, said top wall also having a first end and a second end, each of said first end and said second end of said top wall having a recess therein; and a spring means, said spring means biasing said member outward from said latch bolt housing cavity; said recessed area at said first end of said top wall of said member for receiving a first portion of an opening in a window top rail, said first portion of said top rail opening being positioned between said top plate of said housing and said recess at said first end of said top wall; said recessed area at said second end of said top wall of said member for receiving a second portion of said opening in said window top rail, said second portion of said top rail opening being positioned between said top plate of said housing and said recess at said second end of said top wall; said member thus abutting said window top rail enabling said spring means to thereby biasing said latch bolt housing, with said latch bolt tongue being biased out of an opening in a stile of said window.

68. A method of installing a window latch for a sash window, said method comprising the steps of:
(a) providing a latch to engage a side jam flange on a master frame of said window, where said latches comprises:
(1) a latch bolt; said latch bolt comprising a housing with a latch bolt tongue extending therefrom, said latch bolt tongue having at least a generally flat front surface, said housing further comprising a top plate, a bottom wall, and first and second side walls, said first and second sidewall extending from at least a portion of said top plate, said bottom wall connecting to at least a portion of said first and second side walls, said top plate, bottom wall and first and second side walls therein forming a cavity, said cavity having at least a first opening;
(2) a member, said member comprising a top wall and at least one side wall extending from said top wall; said top wall having a first recess at a first end and a second recess at a second end of said top wall, said member being slidably disposed in said cavity of said latch bolt housing and protruding out an opening in said housing; and
(3) a spring means, wherein said spring means biases said member through said housing opening and out from said cavity, said latch bolt having one or more protrusions to limit outward travel of said member, and wherein at least a portion of said member protrudes from an opening in said latch bolt housing;
(4) a means for retracting said latch bolt, said means comprising a surface on said housing which may be contacted by a user;
(b) forming a pair of coordinated punched openings in said window, one of said coordinated punched openings being in a top rail of said window, and another of said coordinated punched openings being in a stile of said window;
(c) inserting said latch into said coordinated punched opening in said top rail of said window, said tongue being inserted first and being inserted so as to thereafter occupy said coordinated punched opening in said stile;
(d) applying pressure to oppose said bias between said housing and said member so as to compress said spring, and cause said member to be temporarily disposed within said housing cavity;
(e) receiving a first portion of said punched opening in said window top rail, said first portion of said punched top rail opening being positioned between said top plate of said housing and said recess at said first end of said top wall; receiving a second portion of said punched opening in said window top rail, said second portion of said punched top rail opening being positioned between said top plate of said housing and said recess at said second end of said top wall;
(f) said member thus abutting said window top rail enabling said spring means to thereby biasing said latch bolt housing, with said latch bolt tongue being biased out of said coordinated punched opening in said stile of said window, with said generally flat surface of said latch bolt tongue being in line with said side jam flange on said master frame of said window;

69. The method according to claim 68 wherein said coordinated punched openings in the top rail and the stile are rectangular openings.

70. A latch, for use in locking at least one sash of a sash window, said latch comprising:
(a) a latch bolt; said latch bolt comprising a housing, said housing comprising a top plate, a first and a second housing wall extending from said top plate, said top plate overhanging beyond at least a portion of said first housing wall and said second housing wall; said top plate further comprising a means of actuating said latch; said housing further comprising a latch bolt tongue protruding from at least a portion of said first and second housing walls, said tongue protruding beyond said top plate and creating a recess between said tongue and at least a portion of said top plate; said tongue comprising at least a generally flat bearing surface;
(b) a member, said member comprising a first and a second member side wall, said first and second member side walls being joined by at least one connecting wall, said member having a first end and a second end; said at least one connecting wall at said second end of said member having an end wall protruding therefrom, said end wall having a recess; said member being slidably interconnected with said latch bolt housing; and
(c) a spring means, wherein said spring means biases said latch bolt relative to said member.

71. The latch according to claim 70 wherein at least a portion of said member extends beyond said latch bolt housing, and wherein at least a portion of said latch bolt housing extends beyond said member.

72. The latch according to claim 71 wherein said housing further comprises a cavity with an opening; and wherein said first and second member side walls and said at least one connecting wall of said member form a cavity with an opening.

73. The latch according to claim 72 wherein at least a portion of said housing protrudes into said opening of said member to contact a portion of said member, said contact thereby limiting travel of said slidable interconnection in one direction.

74. The latch according to claim 73 wherein at least a second portion of said housing contacts a second portion of said member to thereby limit travel of said slidable interconnection in a second direction.

75. The latch according to claim 74 wherein said latch is installed by receiving a first portion of a window top rail, said first portion of said top rail being positioned between said recess formed by said tongue and said at least a portion of said top plate; and by receiving a second portion of said window top rail, said second portion of said top rail being positioned between said top plate of said housing and said recess in said end wall of said second end of said member.

76. The latch according to claim 75 wherein said means of actuating said latch comprises a toggle button extending from said top plate.
